(19) United States
(12) Patent Application Publication
(10) Pub. No.: US 2005/0070641 A1
(43) Pub. Date: Mar. 31, 2005

(54) Polycarbonate resin composition providing with high light reflectance

(76) Inventors: Chih Yung Liu, Hsinchu Hsien (TW); Liu Chao Chi, Hsinchu Hsien (TW); Sheng Chih Wan, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/673,406

(22) Filed: Sep. 30, 2003

(51) Int. Cl. C08L 69/00

(52) U.S. Cl. 524/94

(57) ABSTRACT

The present invention provides a polycarbonate resin composition of a high light reflectance comprising the following elements. A base material is formed by mixing from 50 to 99% by weight of a polycarbonate resin and from 1 to 50% by weight of a titania (TiO₂). Wherein, one hundred parts of the base material is using as a calculating base. Further, 0.5 to 50 parts by weight of a brightness improver and 0.05 to 0.5 parts by weight of a stabilizer are added to the base material. Hence, the polycarbonate resin of the present invention not only can achieve the effect of high light reflectance, but also can provide with the advantages of the property of the thermal stability and the color stability.

### BACKGROUND OF THE INVENTION

1. Field of the Invention

The present invention generally relates to an optical resin composition, and more particularly relates to a polycarbonate resin providing with excellent stability and high light reflectance.

2. Description of the Prior Art

In view of more and more optical products been used in the usual life of the public, the optical industry make efforts to the enhancement of the efficiency of the optical parts and the reducing cost of the manufacturing. Owing to the plastic optical parts provide with many advantages that those glass optical parts cannot provide, such that advantages of low stuff cost, excellent optical transportation ability, compact, flexible molding design, impact-resisting, high security, and etc. Hence, the plastic optical parts are commonly used in all kind of the optical product.

Polycarbonate (PC) is an industry resin provided with good properties of temperature and humidity, and excellent ability of the wear resistance, and the impact resistance. Usually, the polycarbonate is to apply on the industry of the specific electronics or photo elements. Under some condition, there is high requirement of high light reflectance of the resin material under the visible light. Even in some specific light wavelength, the resin material requires to increase the light reflectance. Currently, the used material is the composite material of the polycarbonate adding titania (TiO₂), wherein the value of the light reflectance of the material is depending on the brightness of the titania and the character of the transparent colorless of the polycarbonate material. It utilizes the transparent character of the polymer to reduce the color interference of the base color of the polymer.

The main aspect of the development of the optical plastic resin technology is to how to enhance the brightness of the material to effectively increasing the light reflectance controlling in the specific light wavelength without seriously sacrificing the mechanical strength and to reduce the color variation. Wherein, the additive 2-(4-(2-(4-(2-benzoxazolyl) phenyl) ethenyl)-′-phenyl)-5-methyl benzoxazole can transform partial ultraviolet light into the visible light so as to provide with the effect of enhancing its brightness of the material. However, there are two side effects herein. One is that its thermal stability of the additive is not good enough and it will cause the material cracking under the long time heat remaining condition to form the gas silver streak on the surface of the injection molding product. The product in the long time heat roasting condition will also cause problems of the yellowing effect and the brightness decreasing. Another side effect is the color variation problem. When the product co-operates with other dynes to control to increase the light reflectance of the light wavelength of a specific region, the color of the made-up product will have the substantially representation of the chromatic aberration. The color variation will not be accepted when the appearance application have high requirement of the accurate coloration.

Obviously, the main spirit of the present invention is to provide a polycarbonate resin composition having a high light reflectance, and then some disadvantages of well-known technology are overcome.

### SUMMARY OF THE INVENTION

The primary object of the present invention is to provide a polycarbonate resin composition having a high light reflectance. A brightness improver and a stabilizer are added to the resin composition to provide the product with not only the optical characteristic of the high light reflectance but also provide with the excellent thermal stability and color stability to effectively overcome prior disadvantages.

Another object of the present invention is to provide a polycarbonate resin composition having a high light reflectance so as the color of the product has no chromatism under the different light source and the resin composition can achieve the appearance requirement of the precisely color matching.

In order to achieve previous objects, the present invention provides a polycarbonate resin composition of a high light reflectance comprising the following elements. A base material is formed by mixing from 50 to 99% by weight of a polycarbonate resin and from 1 to 50% by weight of a titania (TiO₂). Wherein, one hundred parts by weight of the base material is using as a calculating base. Further, 0.5 to 50 parts by weight of a brightness improver and 0.05 to 0.5 parts by weight of a stabilizer are added to the base material.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic representation of the relation between the light reflectance and the light wavelength of the different formula of the resin composition of the present invention.

### DESCRIPTION OF THE PREFERRED EMBODIMENT

The present invention utilizes the polycarbonate adding the titania (TiO₂) as the base material to mix the base material and other elements according the composition proportion so as to form the polycarbonate resin having the high light reflectance.

The high light reflectance polycarbonate resin composition of the present invention comprising a base material, which is comprising from 50 to 99% by weight of a polycarbonate resin and from 1 to 50% by weight of a titania (TiO₂) and one hundred parts by weight of the base material is using as a calculating base. Herein, the one hundred parts by weight of the base material is added about from 0.5 to 50 parts by weight of the brightness improver and about from 0.05 to 0.5 parts by weight of the stabilizer. The brightness improver is 2-(4-(2-(4-(2-benzoxazolyl) phenyl) ethenyl)-phenyl)-5-methyl benzoxazole and the stabilizer is 3-(3′,5′-Di-t-butyl-4′-hydroxy-phenyl) propionyl dihydrazide. The stabilizer provides with the effect of thermal stability and color stability. Furthermore, some additives like the plastic anti-oxidant, dynes, and etc. can further be added to the resin composition.

Wherein, the molecular weight of the polycarbonate is between from 17,000 to 280,000. The preferred molecular weight of the polycarbonate is 22,000. Besides, the high density polyethylene (HDPE) can be further added to the base material so as to enhance the density and improve the mechanical strength. The brightness improver of the composition can transform the partial ultraviolet light to the visible light so as to increase its brightness of the material and to increase the light reflectance. In order to improve the thermal stability and color stability of the whole composition, the present invention utilizes the stabilizer mentioned above to substantially improve the thermal stability of the product and substantially reduce the color variation. Hence, the polycarbonate resin of the present invention not only can provide with the high light reflectance, but also can provide with the advantages of the property of the thermal stability and the color stability.

After the illustration of the high light reflectance polycarbonate resin composition of the present invention, following, there are five practical formula compositions to detail explain the composition of the present invention and the experiment data of its performance so as the person well-known the technology can obtain enough knowledge to embody the present invention according to the description of the examples.

### EXAMPLES

Such as shown in the Table 1, there are elements of five composition examples of A, B, C, D, E in accordance with the present invention.

TABLE 1

Formula

| Composition (PHR) | A | B | C | D | E |
|---|---|---|---|---|---|
| Polycarbonate | 87 | 87 | 87 | 87 | 87 |
| TiO₂ | 12 | 12 | 12 | 12 | 12 |
| Brightness improver | — | 5 | 5 | 5 | 5 |
| Stabilizer | — | — | 0.3 | — | 0.3 |
| Plastic anti-oxidant | 0.1 | 0.1 | 0.1 | 0.1 | 0.1 |
| HDPE | 1 | 1 | 1 | 1 | 1 |
| Green dynes | — | — | — | 1 | 1 |

Wherein, the used pure resin is the polycarbonate and its molecular weight is 22,000, the titania is the R type high purity powder, the plastic anti-oxidant is the Ir1010 anti-oxidant manufactured from the CIBA company, and the green dynes is the GN 28 and its SOLVEN GN is 28.

I Brightness Comparison

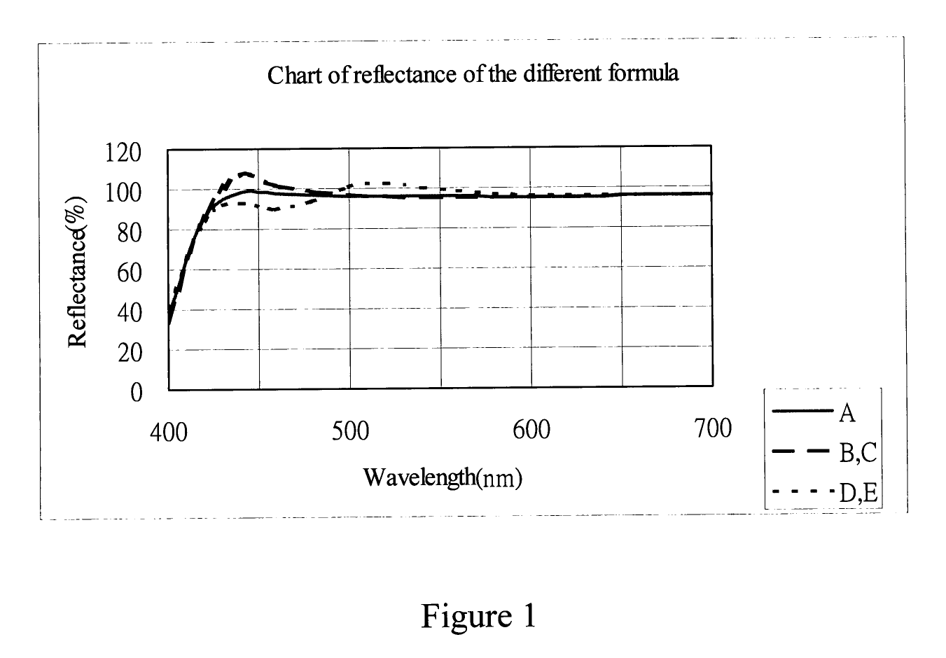

The plastic raw material in accordance with the composition A, B, C, D, and E of the Table 1 are formed color boards, wherein each is with a smooth surface. Then, under different light wavelength, the spectrophotometer is used to measure the brightness (or lightness) of those five color boards. The data of brightness of those compositions measured are shown in the Table 2. As shown in the FIG. 1, which is charting according the Table 2, formulas of the composition B and the composition C are merely different on if the additive of the stabilizer is added. Formulas of the composition D and the composition E are also different on if the additive of the stabilizer is added. The stabilizer does not influence on the color appearance of the product, so compositions of B and C and composition D and E are put in the same column in the Table 2.

TABLE 2

| Wavelength (nm) | A | B, C | D, E |
|---|---|---|---|
| 400 | 37.85 | 33.4 | 39.9 |
| 420 | 86.35 | 86.2 | 84.7 |
| 440 | 98.13 | 107.3 | 92.5 |
| 460 | 97.50 | 101.6 | 89.9 |
| 480 | 97.12 | 98.7 | 93.6 |
| 500 | 96.34 | 97.2 | 100.9 |
| 520 | 95.77 | 95.9 | 102.7 |
| 540 | 95.65 | 95.3 | 100 |
| 560 | 95.66 | 95.2 | 98.4 |
| 580 | 95.5 | 95 | 96.9 |
| 600 | 95.5 | 95.1 | 96.3 |
| 620 | 95.55 | 95.2 | 96 |
| 640 | 95.6 | 95.4 | 96.1 |
| 660 | 95.77 | 95.9 | 96.4 |
| 680 | 96.04 | 95.8 | 96.3 |
| 700 | 96.19 | 95.7 | 96.2 |

Under the Xe arc light source, which is in accordance with the D65 light source defined by the Commission International Commission on Illumination (CIE), the spectrophotometer is used to directly measure those brightness data (the L value) of those color boards of five compositions, the measured L values are shown in the Table 3.

TABLE 3

| | A | B | C | D | E |
|---|---|---|---|---|---|
| L value | 96.7 | 98.4 | 98.1 | 99.3 | 98.8 |

As shown in the Table 3, compositions of B, C, D and E is comprising the brightness improver and the composition A does not add the brightness improver. Referring to the result of the color measuring in the Table 3, the brightness improver actually has the directly improved effect of enhancing the light reflectance of the material.

II Heat Retention Test Comparision

The plastic raw materials in accordance with the composition A, B, C, D, and E of the Table 1 are respectively formed color boards by the injection molding process under 280° C. However, before the injection molding, the material is remained six minutes in the material pipe for comparing the effect of the heat retention on the surface properties of the formed color boards. The result is as shown in the Table 4 and it shows that the stabilizer can effectively improve the heat resistance of the whole compositions.

TABLE 4

| | A | B | C | D | E |
|---|---|---|---|---|---|
| Silver streak | Slightly | Seriously | None | Seriously | None |

III Heat-Roasting Test

According to the raw material of the composition A, B, and C to form color boards under the normal condition, the spectrophotometer is used to measure the color property of color boards as the control group. Then, those color boards are put into the oven and roasted under 120° C. with one hundred hours. After that, color boards are taken out to measure the color properties to compare with the control group and the result is shown in the Table 5. According to the definition of the C.I.E., the brightness is represented as the L value, the red green value is represented as the a value, and the yellow blue value is represented as the b value. Utilizing these three data can calculate the chromatism value (ΔE) and the calculating formula equation is as the following.
ΔE=(ΔL²+Δa²+Δb²)^{1/2}

As the representation of the Table 5, the discolor effect of the material causing from the heat is very seriously without the protection of the stabilizer.

TABLE 5

| | Control Group | | | Comparative Group | | | |
|---|---|---|---|---|---|---|---|
| | L | a | b | L | a | B | Chromatism value |
| A | 96.7 | −0.7 | 1.0 | 96.6 | −0.7 | 0.6 | 0.4 |
| B | 98.4 | 0.3 | 2.7 | 96.2 | 0.3 | 1.8 | 2.4 |
| C | 98.1 | 0.3 | 2.5 | 97.7 | 0.2 | 1.9 | 0.7 |

IV Color Variation Estimation

Color boards formed according the raw material of the composition D and E are measured the color properties by using the spectrophotometer with respectively using the UV light including condition and then compared the chromatism value with each other. The comparison result is as shown in the Table 6.

TABLE 6

| | UV including | | | UV deleting | | | |
|---|---|---|---|---|---|---|---|
| | L | a | b | L | a | B | Chromatism value |
| D | 99.3 | −4.2 | 5.3 | 99.2 | −4.2 | 6.3 | 1.0 |
| E | 98.8 | −4.1 | 5.7 | 98.8 | −4.2 | 5.6 | 0.1 |

Under different UV-illuminating conditions, the difference of the chromatism value of the same color board of the composition D is 1.0; it means the serious color variation. With the color stable requirement of the product appearance, this could not achieve the requirement. However, the color board of the composition E does not have the color variation phenomenon. Hence, adding the stabilizer can effectively improve the color variation problem.
V Mechanical Property Estimation

The plastic raw material in accordance with the composition A, B, C, D, and E of the Table 1 are formed color boards under the normal condition. Then, five color boards are performed various kind of mechanical properties tests, including the melting index (MI) test, the impact strength test, the tensile strength test and the heat deflection temperature test. Standers and the result of each test are listed in the Table 7, the result shows that the brightness improver and the stabilizer do not influence the mechanical properties of the formed product and all mechanical properties of the formed products is within the normal value.

TABLE 7

| | Testing | | | | | | |
|---|---|---|---|---|---|---|---|
| Item | Method | Unit | A | B | C | D | E |
| Melting | ASTM D1238 | g/10 min | 10.6 | 12.9 | 10.3 | 13.2 | 10.5 |
| index | | | | | | | |
| Impact | ASTM D256 | kg cm/cm | 28 | 32 | 31 | 32 | 29 |
| Strength | | | | | | | |
| Tensile | ASTM D638 | kg/cm² | 627 | 610 | 623 | 622 | 615 |
| Strength | | | | | | | |
| Heat | ASTM D648 | ° C. | 133 | 132 | 133 | 132 | 133 |
| De- | | | | | | | |
| flection | | | | | | | |
| Tem- | | | | | | | |
| perature | | | | | | | |

Hence, the present invention utilizes the additive of the brightness improver coupling with the use of the dynes, so as the present invention can control the polycarbonate resin to effectively enhance the light reflectance in some specific light wavelength. Simultaneously, the present invention uses the additive of the stabilizer mentioned above to provide the product with excellent thermal stability and the color stability. Under the long time of the heat retention condition, the product does not easily crack and does not cause the silver streak on the product surface. Further, under the long time of the heat roasting condition, the product does not cause the discolor effect. Furthermore, the product can achieve the high requirement of the accurate coloration of the appearance application and does not have the representation of the chromatism under different light source.

The forgoing description of the embodiments of the invention has been presented for purposes of illustration and description, and is not intended to be exhaustive or to limit the invention to he precise from disclosed. The description was selected to best explain the principles of the invention and practical application of these principles to enable others skilled in the art to best utilize the invention in various embodiments and modifications as are suited to the particular use contemplated. It is intended that the scope of the invention not to be limited by the specification, but be defined by the claim set forth below.

1. A polycarbonate resin composition provides with a high light reflectance comprising the following elements:
a base material comprising from 50 to 99% by weight of a polycarbonate resin and from 1 to 50% by weight of a titania (TiO₂), wherein one hundred parts by weight of said base material is using as a calculating base;
0.5 to 50 parts by weight of a brightness improver; and
0.05 to 0.5 part by weight of a stabilizer.

2. The polycarbonate resin composition provides with a high light reflectance according to claim 1, wherein said brightness improver is 2-(4-(2-(4-(2-benzoxazolyl) phenyl) ethenyl)-phenyl)-5-methyl benzoxazole.

3. The polycarbonate resin composition provides with a high light reflectance according to claim 1, wherein said stabilizer is 3-(3′, 5′-Di-t-butyl-4′-hydroxy-phenyl) propionyl dihydrazide.

4. The said polycarbonate resin composition provides with a high light reflectance according to claim 1, wherein a molecular weight of said polycarbonate resin is about 17,000 to 28,000.

5. The said polycarbonate resin composition provides with a high light reflectance according to claim 1, further comprises a plastic anti-oxidant.

6. The said polycarbonate resin composition provides with a high light reflectance according to claim 1, further comprises dyes.

7. The said polycarbonate resin composition provides with a high light reflectance according to claim 1, wherein said base material further comprises a high-density polyethylene.
